(19) United States
(12) Patent Application Publication
(10) Pub. No.: US 2025/0330020 A1
(43) Pub. Date: Oct. 23, 2025

(54) METHODS AND PROCESSES FOR POWER TRANSMISSION

(71) Applicant: SAUDI ARABIAN OIL COMPANY, Dhahran (SA)

(72) Inventor: Wasseem Ali Alkhardawi, Dhahran (SA)

(73) Assignee: SAUDI ARABIAN OIL COMPANY, Dhahran (SA)

(21) Appl. No.: 18/638,345

(22) Filed: Apr. 17, 2024

(51) Int. Cl. H02J 3/16; G06Q 30/018; G06Q 50/06; H02J 3/32

(52) U.S. Cl. CPC H02J 3/16; G06Q 30/018; G06Q 50/06; H02J 3/32

(57) ABSTRACT

Methods and systems use a power management system having a power management system controller. The method includes monitoring a load demand of a power distribution system including renewable resources such as solar system having at least one subregional grid. The method includes communicating a power curve based, at least in part, on the load demand from each subregional grid to the power management system, analyzing the power curve. The method includes selectively distributing, using a back-to-back converter transmission system, power from at least one power generation system to each subregional grid, wherein the selective distribution is based, at least in part, on the power curve.

### BACKGROUND

Power demand has steadily increased over time. The number of different methods for power generation have also increased to meet the increased demand. Different methods for power generation may include wind, solar, nuclear, oil, natural gas, and coal. Systems are needed to transmit the power to where the demand is located. Power loads resulting in power demand from power generation systems may include residential housing, businesses, public buildings, and factories. Power demand varies over the course of a twenty-four-hour period. Systems and methods should be available to meet the demand.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a method for distribution of power. The method may include, using a power management system having a power management system controller. The method may include monitoring a load demand of a power distribution system having at least two subregional grids. The method may include communicating a power curve based, at least in part, on the load demand from each subregional grid to the power management system. The method may include analyzing the power curve. The method may include selectively distributing, using a back-to-back converter transmission system, power from at least one power generation system to each subregional grid. The selective distribution may be based, at least in part, on the power curve.

In some aspects, the techniques described herein relate to a system for distribution of power, including a power management system. The power management system may include a power management system controller configured to monitor a load demand of a power distribution system having at least two subregional grid. The power management system controller may also be configured to communicate a power curve based, at least in part, on the load demand from each subregional grid to the power management system. The power management system controller may also be configured to analyze the power curve. The system may include a back-to-back converter transmission system configured to selectively distribute power from at least one power generation system to each subregional grid. The selective distribution may be based, at least in part, on the power curve.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example of a power generation system in accordance with one or more embodiments.

FIG. 2 depicts a power system in accordance with one or more embodiments.

FIG. 3A depicts one or more power curves in accordance with one or more embodiments.

FIG. 3B depicts one or more power curves in accordance with one or more embodiments.

FIG. 4 shows a flowchart in accordance with one or more embodiments.

FIG. 5 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

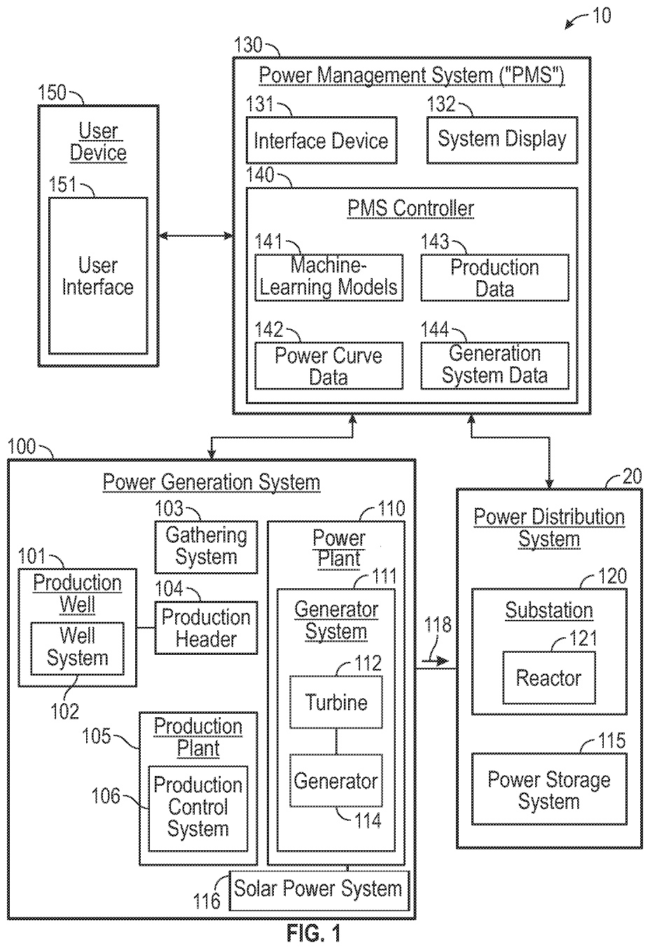

In the following description of FIGS. 1-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are methods and systems for power generation and transmission. The present invention may include power generation systems configured to use coal, natural gas, nuclear, wind, and/or solar. The systems may include power plants, both conventional and unconventional. Embodiments of the present invention may include power transmission systems that selectively distribute power output from the power plants to various subregional grids. Subregional grids may include residential, and/or commercial areas requiring electrical power. The transmission systems may be configured to transmit using alternating current that are supported by one or more substations. The substations may include back-to-back converters. The substations may allow full control of the direction and magnitude of the power transmission. Embodiments of the present invention include a power management system that may be configured to continuously monitor the load demands of the one or more subregional grids and the power output from one or more power generation systems. The power management system may be configured to distribute power based at least in part on the load demand.

FIG. 1 depicts an example embodiment of a system for generation and distribution of power (hereafter “power system”) (10). The power system (10) includes one or more power generation systems (e.g., a gas production network) (100) and a distribution system (20). One of the power generation systems (100) may include a production well (e.g., a gas well and/or an oil well) (101), one or more production plants (105), one or more power plants (105), one or more user devices (150), and various network elements (not shown). In one or more embodiments, the power system (10) includes a power management system (“PMS”) (130) having a PMS controller (140). In one or more embodiments, the PMS controller (140) may be a power plant server. In some embodiments, various types of system data are collected over the power system (10). The system data may include, but not limited to, production data (143), power curve data (142) and/or generation system data (144) regarding one or more components and/or systems providing power production and distribution throughout the power system (10).

Even though the power generation system (100) as described in FIG. 1 and accompanying description depicts a power generation system (100) that is configured to produce and use hydrocarbons (e.g., oil and/or gas) it will be apparent to a person having ordinary skill in the art that the power generation system (100) could be configured to produce and use any type of power generation such as, but not limited to, coal, nuclear, wind, solar, or any combination thereof. A conventional power plant may be considered a power plant configured to use nuclear, coal and/or hydrocarbons to produce power. An unconventional power plant may be considered a power plant configured to use renewable sources such as solar, and/or wind to produce power. A power plant configured to use solar energy may also be a commercial solar power system, or a residential solar power system.

In accordance with one or more embodiments, the production well (101) may include a well system (102) located in a well environment that includes a hydrocarbon reservoir (“reservoir”) located in a subsurface hydrocarbon-bearing formation. The hydrocarbon-bearing formation may include a porous or fractured rock formation that resides underground, beneath the earth's surface (“surface”). In the case of the well system (102) being a hydrocarbon well, the reservoir may include a portion of the hydrocarbon-bearing formation. The hydrocarbon-bearing formation and the reservoir may include different layers of rock having varying characteristics, such as varying degrees of permeability, porosity, and resistivity. In the case of the well system (102) being operated as a production well (101), the well system (102) may facilitate the extraction of hydrocarbons (or “production”) from the reservoir. In some embodiments, the well system (102) includes a wellbore, a well sub-surface system, a well surface system, and a well control system.

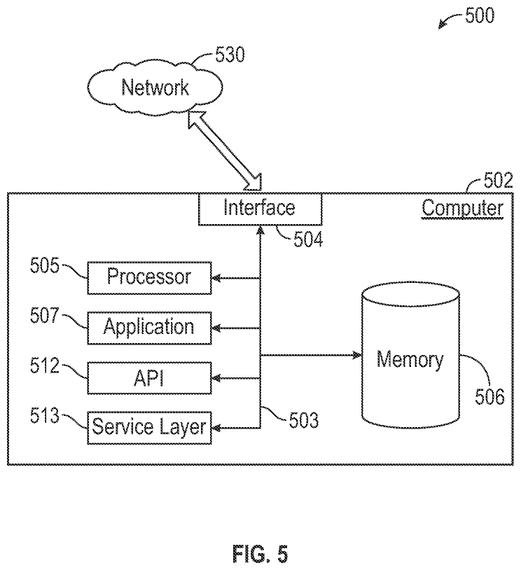

In some embodiments, the wellbore may include a bored hole that extends from the surface into a target zone of the hydrocarbon-bearing formation, such as the reservoir. The wellbore may facilitate the circulation of drilling fluids during drilling operations, the flow of hydrocarbon production (“production”) (e.g., oil and/or gas) from the reservoir to the surface during production operations, the injection of substances (e.g., water) into the hydrocarbon-bearing formation or the reservoir during injection operations, or the communication of monitoring devices (e.g., logging tools) into the hydrocarbon-bearing formation or the reservoir during monitoring operations (e.g., during in situ logging operations). The well control system in the well system (102) may control various operations of the well system (102), such as well production operations, well completion operations, well maintenance operations, and reservoir monitoring, assessment and development operations. In some embodiments, the well control system includes a computer system that is the same as or similar to that of computer system (500) described below in FIG. 5 and the accompanying description.

In some embodiments, one or more gas wells are coupled to a gathering system (103). A gathering system (also referred to as a collecting system or gathering facility) may include various hardware arrangements and pipe components that connect gas flowlines from several gas wells into a single gathering line. For example, a gathering system may include flowline networks, headers, pumping facilities, separators, emulsion treaters, compressors, dehydrators, tanks, valves, regulators, and/or associated equipment. In particular, a production header (104) may have production valves and testing valves to control a mixed stream for a flowline of a respective gas well. Thus, a gathering system may direct various hydrocarbon fluids to a processing or testing facility, such as a production plant. Once collected, the gathering system may transport and control the flow of oil or gas to a storage facility, a gas processing plant, or a shipping point.

Keeping with FIG. 1, the production may be transported from one or more production wells (101) to one or more production plants (e.g., a gas plant) (105), such as through one or more mixed fluid streams (e.g., mix fluid stream). More specifically, the production plant (105) may refer to various types of industrial plants such as a gas processing plant, a gas cycling plant, or a compressor plant. A gas processing plant (also referred to as a natural gas processing plant) may be a facility that processes natural gas to recover natural gas liquids (e.g., condensate, natural gasoline, and liquefied petroleum gas) and sometimes other substances such as sulfur. A gas cycling plant may refer to an oilfield installation coupled to a gas-condensate reservoir. In particular, a gas cycling plant may extract various liquids from natural gas. Consequently, the remaining dry gas may be compressed prior to returning to a producing formation, e.g., to maintain reservoir pressure. With respect to compressor plants, a compressor plant may be a facility that includes multiple compressors, auxiliary treatment equipment, and pipeline installations for pumping natural gas over long distances. A compressor station may also repressurize gas in large gas pipelines or to link offshore gas fields to their final terminals.

In some embodiments, each production plant (105) may include one or more pipe components, one or more storage facilities, and one or more production control systems (106). For example, different forms of gas may be stored in various storage facilities that include surface containers as well as various underground reservoirs, such as depleted gas reservoirs, aquifer reservoirs and salt cavern reservoirs. With respect to production control systems, each production control system (106) may include hardware and/or software that monitors and/or operates equipment, such as at a production well or in a production plant. Examples of production control systems may include one or more of the following: an emergency shut down (ESD) system, a safety control system, a video management system (VMS), process analyzers, other industrial systems, etc. In particular, a production control system may include a programmable logic controller that may control valve states, fluid levels, pipe pressures, warning alarms, pressure releases and/or various hardware components for implementing a gas flowline. Thus, a programmable logic controller may be a ruggedized computer system with functionality to withstand vibrations, extreme temperatures, wet conditions, and/or dusty conditions, such as those around a gas plant, gas well, and/or a gathering system.

In accordance with one or more embodiments, each production control system (106) may be a computer system for managing various processes at a facility using multiple control loops such as a distributed control system. As such, a distributed control system may include various autonomous controllers (such as remote terminal units (RTUs)) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system.

Keeping with production control systems, each production control system (106) may be coupled to facility equipment. Facility equipment may include various machinery such as one or more hardware components, such as pipe components, that may be monitored using one or more sensors. Examples of hardware components coupled to a control system may include crude oil preheaters, heat exchangers, pumps, valves, compressors, loading racks, and storage tanks among various other types of hardware components. Hardware components may also include various network elements or control elements for implementing control systems, such as switches, routers, hubs, PLCs, remote terminal units, user equipment, or any other technical components for performing specialized processes. Examples of sensors may include pressure sensors, flow rate sensors, temperature sensors, torque sensors, rotary switches, weight sensors, position sensors, microswitches, hydrophones, accelerometers, etc. A power management system, user devices, and network elements may be computer systems similar to the computer system (502) described in FIG. 5 and the accompanying description.

The generator system (111) may be used in power plants, refineries, chemical plants, and stationary applications to generate power and electricity. The generator system (111) may include a turbine (112) and a generator (114). The generator (114) is operatively connected to the turbine (112) with a shaft configured to provide rotation from the turbine (112) to the generator (114). Air enters the turbine (112) through an air inlet and flows through a compressor section. The compressor section may contain one compressor, or multiple compressors, depending on the application. In the compressor section, air is compressed. During the compression of air in compressor section, the pressure and the temperature of the air may increase. The compressed air exiting compressor section passes through a combustion chamber. The combustion chamber comprises a fuel injection site, through which fuel enters combustion chamber.

In some embodiments, the fuel may be sourced from the production plant (105). The fuel and the compressed air inside combustion chamber react chemically and produce combustion products which exit combustion chamber and enter a turbine section. The turbine section may contain a single turbine or multiple turbines. The combustion products flow through turbine section and expand. The turbine section produces rotational work, which may be used to rotate the generator (114). The rotation of the generator (114) produces electricity. The expanded combustion products exiting turbine section then exit the gas turbine through an exhaust section.

In accordance with one or more embodiments, the power distribution system (20) may include a power storage system (115). The power storage system (115) may include one or more batteries configured to store power from the one or more power plants (110). The power generation system (100) may be configured to direct power output (118) to the power storage system (115). The batteries may include, but not limited to, nickel cadmium, lead acid, lithium ion, and/or flow batteries. The PMS (130) may be configured to control the direction of flow from various loads such as power grids and/or to the power storage system (115). The PMS (130) may include hardware and/or software for managing the direction and magnitude of power flow to and/or from the power storage system (115).

In some embodiments, the PMS (130) includes hardware and/or software for collecting data in real-time from various gas wells, gas plants, power plants, sensors coupled to hardware equipment and pipe components, user devices, and other systems in the power generation system (100). For example, a PMS may be one or more plant servers with functionality for obtaining data throughout the power generation system (100), such as production data (e.g., gas flowline data) (143), and/or power curve data (e.g., power output data, load data) (142). For example, gas flowline data may include operating upstream and downstream sensor data for various pipe components (e.g., pressure data, temperature measurements, and gas flow rates), and safety system status updates from various pipeline information (PI) systems, such as management systems located throughout the power generation system (100). The power curve data (142) may include, but not limited to, power output (e.g., megawatt (“MW”) output) (118) over time from each power plant (110).

In some embodiments, the PMS (130) includes functionality for determining and/or implementing one or more systemic operations based on production data (143), power curve data (142), and/or generation system data (144). A systemic operation may include replacing a particular component that is part of the power generation system (100) based on the component failing to satisfy a predetermined criterion (e.g., power output (118) of the generator system (111) falling below an output threshold). Likewise, a systemic operation may also include adjusting production plant operations to manage power generation levels.

In some embodiments, a user device (150) may communicate with the flowline corrosion manager to present integrity assessment reports to a particular user. Based on the integrity assessment reports, the user device (150) may also manage various commands for performing one or more systemic operations based on one or more user selections. The user device (150) may be a personal computer, a handheld computer device such as a smartphone or personal digital assistant, or a human machine interface (HMI). For example, a user may interact with a user interface (e.g., graphical user interface presented on a display device) (151) to inquire regarding power generation states and integrity levels in one or more components at the production plant (105). Through user selections or automation, the power management system may identify components that fail integrity criteria and implement systemic operations accordingly. As such, a PMS (130) may provide agility and flexibility in determining the states of various system as well as implement operations to carry out power generation.

Continuing with FIG. 1, the PMS (130) may include hardware and/or software with functionality for generating and/or updating one or more machine-learning models (141) to determine predicted power curve data, predicted generation system data, and/or predicted production data. Examples of machine-learning models (141) may include random forest models and artificial neural networks, such as convolutional neural networks, deep neural networks, and recurrent neural networks. Machine-learning models (141) may also include support vector machines, decision trees, inductive learning models, deductive learning models, supervised learning models, unsupervised learning models, reinforcement learning models, etc. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network. In some embodiments, two or more different types of machine-learning models (141) are integrated into a single machine-learning architecture, e.g., a machine-learning model may include K-nearest neighbor (k-NN) models and neural networks. In some embodiments, a reservoir simulator may generate augmented data or synthetic data to produce a large amount of interpreted data for training a particular model.

In some embodiments, various types of machine-learning algorithms may be used to train the machine-learning models (141), such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning models (141).

In some embodiments, machine-learning models (141) may be is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, machine-learning models (141) may be trained iteratively using epochs until the model achieves a predetermined criterion, such as predetermined level of prediction accuracy or training over a specific number of machine-learning epochs or iterations. Thus, better training of a model may lead to better predictions by a trained model.

In some embodiments, a reservoir simulator uses one or more machine-learning methods to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

In some embodiments, each power plant (110) may be operatively connected to the PMS (130). The PMS (130) may be configured to control and monitor the distribution of power output in the power distribution system (20). In one or more embodiments, the power distribution system (20) may include one or more substations (120) having one or more reactors (121). The reactors (121) may be variable shunt reactors configured to adapt upon receiving immediate feedback or control instructions from the PMS (130).

In accordance with one or more embodiments, the PMS (130) is used to maintain robustness of the connection between one or more power stations operatively connected using transmission cables and/or overhead transmission lines alone (i.e., without requiring transformers installed along the distance) to one or more subregional grids. In some embodiments, the PMS (130) controls a compensating voltage of variable reactors of the one or more substations (120) to meet any reactive power requirements resulting from running transmission cables over long distances. The PMS (130) may be located on either end of the long distance. In one or more embodiments, the PMS (130) is located at both ends of the long distance such that two PMSs may be configured for controlling power output distribution in an entire power distribution system. In some embodiments, one PMS may be a primary PMS used for controlling the entire power distribution system, while an additional PMS may be a secondary PMS used as a hot standby for the primary PMS when, for example, the primary PMS is disconnected for maintenance. Further, in the event of a system disturbance, either PMS may assume control of the entirety of the distributed electrical power system.

While FIG. 1 shows various configurations of components, other configurations may be used without departing from the scope of the disclosure. For example, various components in FIG. 1 may be combined to create a single component. As another example, the functionality performed by a single component may be performed by two or more components.

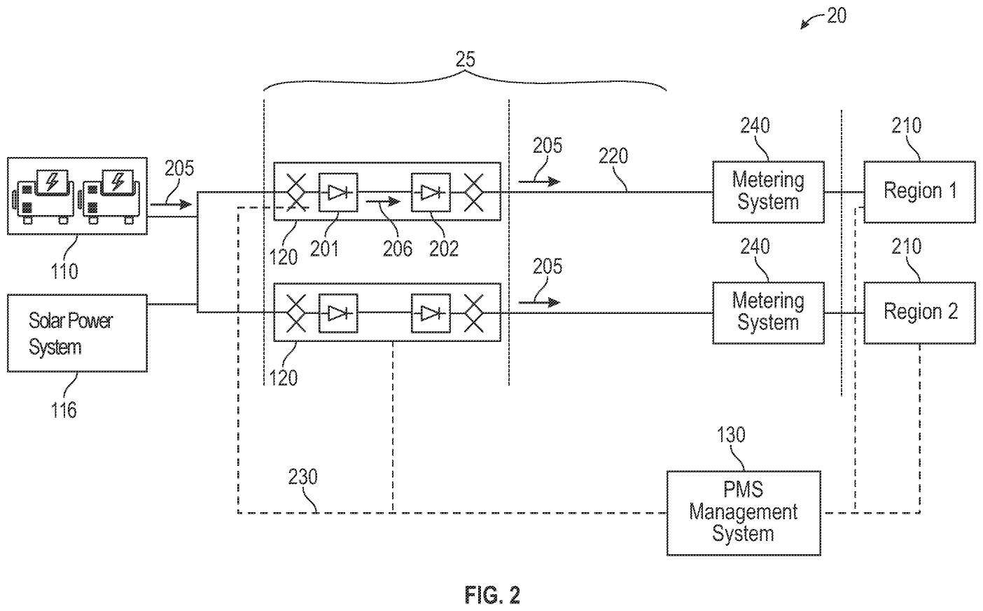

FIG. 2 shows a schematic diagram illustrating an example embodiment of a power distribution system (20). The power distribution system (20) is operatively connected to the one or more production plants (105) of the power generation system (100) (e.g., a gas plant and/or a solar power system (116)). Two or more production plants may be located at different locations separated over long distances. In some embodiments, one or more substations (120) are connected to two or more subregional grids (210) using at least one transmission cable (220). The transmission cables (220) may include power cables suitable for power transmission. In some embodiments, the at least one transmission cable may be buried underground. In some embodiments, the at least one transmission cable and/or overhead transmission line is positioned on the water bottom if the two or more subregional grids are separated by a body of water (e.g., an ocean or a lake) from the substations (120). Each production plant (105) is operatively connected to the one or more substations (120).

The one or more substations (120) may be a combination of substation equipment configured for receiving power output from a power grid outside of the one or more power plants (110) and delivering processed power to other locations of the one or more power plants (110). The power load may be one or more subregional grids (210). In some embodiments, the power load may be hardware located on the production plant (105) which requires using processed power from the substations (120). The power load may be electric equipment used in oil and gas applications including a resistive load (e.g., a drilling rig). The PMS (130) may be used to control power output distribution in the substations (120), further controls the voltage at both sides of the transmission cables (220) by regulating the corresponding reactors of each substation (120).

In some embodiments, the PMS (130) may include one or more PMS controllers (140) to control all reactors located along the power distribution system (20). The PMS controller (140) may be redundant and communicating constantly such that one PMS controller may fully control all substations and reactors and another PMS controller may be a hot standby. In this regard, the one or more PMS controllers (140) may dynamically maintain electrical parameters (i.e., voltages and power factors) within acceptable limits in all loading scenarios for facilities located in the power distribution system (20). Advantageously, in some embodiments, dynamically maintaining electrical parameters eliminates plant shutdowns due to overvoltage caused by changing loading conditions. To this point, the PMS controllers (140) constitute a fully automated system for all reactors while meeting requirement of all the loading scenarios.

Continuing with FIG. 2, the PMS controller (140) may be connected to one another through optic fiber cables such that both PMS controllers may maintain a constant communication link, in accordance with one or more embodiments. In some embodiments, the one or more PMS controllers may maintain a same control outreach over the power being delivered in the entire power distribution system. In this regard, the PMS controllers (140) may have control links for monitoring and modifying conditions in the substations (120). Specifically, either PMS controller may be configured to control any of the reactors through one or more control lines (230).

In some embodiments, using transmission cables (220), the power distribution system (20) may deliver power output (118) from each power plant (110) (e.g., a gas plant and/or a solar power system (116)) to the one or more subregional grids. In one or more embodiments, when one PMS that is operating as a primary PMS is taken offline, another PMS operating as a hot standby may take over management of the power distribution system (20) such that operations in the power distribution system (20) may continue without requiring any downtime of the power distribution system (20). In one or more embodiments, the transmission cables (220) may be disposed in one or more of the cables described in reference to FIG. 1.

In one or more embodiments, controlling the reactors (121) dynamically and automatically at both sides of a cable through the PMS (130) may avoid any system overvoltage and ensure reliable power supply system in loading scenarios. Specifically, overvoltage risks may be mitigated by constantly monitoring the system and automatically adjusting the reactive compensation from the reactors (121).

In some embodiments, the PMS (130) includes electronic components that enable the PMS (130) to perform load monitoring functions, data collecting functions, and/or processing functions. In some embodiments, the electronic components may be configured to create communication links and control links with each element in the power distribution system (20). In some embodiments, the electronic components of the PMS (130) may be a combination of hardware and software including a load monitoring system, a control system, a sensing system, and the power distribution system (20). In some embodiments, these electronic components communicate with one another through wired or wireless connections for exchanging collected data and processed data. In this regard, connections including control communications may be implemented using wires or wireless protocols while connections including power transmissions may be implemented using wires rated for a specific voltage.

In some embodiments, the PMS (130) may be complete integrated in the power distribution system (20) for protection, control and automation of the power plants (110). These functions may require devices such as protective relays, embedded computers, logic controllers, I/O modules, and communications and engineering tool sets. A communications architecture for the PMS (130) may be using fully redundant time-division multiplexing-based networks connecting all power plants.

In some embodiments, a PMS (130) may perform adaptive measurements for changing dynamically and determining a subregional grid operation for the generator system (111) based on one or more power curves. Because power curves may change during system operation, the allowable operational subregional grid may be dynamically adjusted by the PMS (130) depending on any power curve parameter relating to the power distribution system (20) (i.e., resistive load or reactive power change) and any fixed operator-entered regulation limits.

In some embodiments, the PMS (130) may be configured to operate over a span of seconds or minutes to slowly correct the system frequency, voltage, active and reactive power flows, power factor, and more. The PMS (130) may be configured to control the active and the reactive power flow from generators. The PMS (130) may be operatively connected to generator unit controllers of the power plants (110) using an interface device (131) that sends and receives control and status signals. The interface device (131) may be integrated with a system display (132) for visually displaying various parameters and system status of the power system (10).

In one or more embodiments, the PMS (130) may include various peripherals and instruments used by the PMS (130) to identify external parameters surrounding the power distribution system (20). In some embodiments, the PMS (130) may include I/O modules, at least one front-end processor, and meters and relays. These devices may be incorporated into instrumentation devices and management systems disposed in other portions of the PMS (130).

In some embodiments, the PMS (130) may be used to synchronize individual generators to the one or more subregional grids. The PMS (130) may be required to function automatically with minimal human supervision because they must dispatch multiple generators simultaneously to reduce slip and voltage differences at any one of the interconnection points. In some embodiments, the PMS measures the voltage and frequency on both sides of several breakers (bus couplers, bus ties, and tie line breakers) to send proportional correction pulses for adjusting electronic parameters as necessary to automatically close a breaker. Advantageously, this process enables safe, secure, unattended synchronization of the generators connected to one bus and the generators on the opposing bus. In the event of a PMS being a hot standby PMS, the synchronization system may perform coupling operations to take over operations controls previously performed by a primary PMS.

In some embodiments, the PMS (130) may be used to perform curtailment for the solar power system as a backup protection for the power plant (110).

FIG. 2 shows an example embodiment of the power distribution system (20) that controls transmission, production and/or distribution of power output toward one or more electronic components within one or more subregional grids. In some embodiments, the power distribution system (20) receives inbound power from another power plant or another power distribution system outside of the power distribution system (20). In some embodiments, the power plant (110) may transmit outbound power to another power station or a power distribution system outside of the power distribution system (20). The power distribution system (20) may include a metering system. The PMS (130) may monitor and control all operations of the of the metering system (240). The metering system (240) may be configured to communicate power usage of the one or more subregional grids (210).

In accordance with one or more embodiments, the power distribution system (20) may include a back-to-back converter transmission system (25). Each substation (120) may include a back-to-back converter configuration. Each substation (120) having the back-to-back converter configuration is operatively connected to one or more subregional grids (210). Each substation (120) having the back-to-back converter configuration includes at least two converters such as a voltage source converter (“VSC”). In some embodiments, the back-to-back converter transmission system (25) may include a generator-side converter (201) and a grid-side converter (202). The generator-side converter (201) may receive power transmission from the generator system (111). The power transmission from the generator system (111) may be configured for alternating current (“AC”) power transmission (205). The generator-side converter (201) may be configured to convert the AC power transmission to direct current (“DC”) power transmission (206). The generator-side converter (201) is operatively connected to the grid-side converter (202). The grid-side converter (202) may be configured to convert the DC power transmission (206) to AC power transmission (205). In some embodiments, the back-to-back converter transmission system (25) may use AC power transmission to each subregional grid as the mode of transmission.

In some embodiments, the power distribution system (20) may include frequency transformers, current transformers, and a potential transformer. In some embodiments, the instrument transformers are static devices utilized for reduction of higher currents and voltages. In some embodiments, the current transformers are devices utilized for the transformation of higher value currents into lower values. The current transformers may be utilized in an analogous manner to that of AC instruments, control apparatus, and meters. In some embodiments, potential transformers may be utilized for converting high voltages to lower voltages for protection of relay system and for lower rating metering of voltage measurements.

In some embodiments, the power distribution system (20) may include conductors, insulators, a switchyard, and busbars. In some embodiments, the conductors are materials which permit flow of electrons through it. In the power plant (110), these materials may be copper and aluminum bars. The conductors may be utilized for transmission of power from place to place over various power stations. In some embodiments, insulators are the materials which do not permit flow of electrons throughout. In some embodiments, the switchyard may be a combination of devices and infrastructure configured for distributing electric power in a closed area. In some embodiments, busbars may be a kind of electrical junction which has outgoing and incoming current paths. If a fault occurs in the busbars, entire components connected to that specific section may be tripped for giving thorough isolation in a small time.

In some embodiments, the metering system (240) may include carrier current equipment, a surge voltage prevention system, and outgoing feeders. In some embodiments, the carrier current equipment may be installed in the power plant (110) for the purpose of communication, supervisory control, telemetry, and/or relaying. Such equipment may be mounted on a room which is known as carrier room and is connected across power circuit handling high voltages. In some embodiments, the surge voltage prevention system may be hardware and/or software configured to prevent voltage surges. There are several reasons for overvoltage which may be caused due to a sudden alteration in conditions of the system (e.g., load rejection, faults, or switching operations) or because of natural reasons (e.g., lighting). In some embodiments, the outgoing feeders may connections to a bus of the power plant (110) for carrying power from the power plant (110) to service points or dissipaters.

In some embodiments, the power distribution system (20) may include lighting arrestors, circuit breakers, relays, reactors, batteries, and wave trappers. In some embodiments, the lighting arrestors may be protecting equipment to protect the power plant (110) from high voltages while limiting the amplitude and duration of a current's flow. In some embodiments, the circuit breakers may be switches utilized for closing or opening circuits at the time when a fault occurs within the system. In some embodiments, the relays may be a dedicated component of electrical substation equipment for the protection of system against abnormal situations (e.g., faults). Relays may be sensing devices which are devoted for sensing faults and are determining its location as well as sending interruption message of tripped command to the specific point of the circuit. In some embodiments, the reactors (121) may be defined as a set of numerous identical capacitors which are connected either in parallel or series inside an enclosure and are utilized for the correction of power factor as well as protection of circuitry of the power station. These may act as the source of reactive power and are thus reducing phase difference amid current and voltage. The reactors (121) may increase a capacity of ripple current in a power supply. In some embodiments, the batteries may be power storage units. In some embodiments, the wave trappers may be devices for trapping of high-frequency waves or reflections. The high-frequency waves coming from other power stations or other localities may disturb the current and voltages. As such, the wave trapper may be basically tripping high-frequency waves and is then diverting the waves into telecom panel.

Those skilled in the art will appreciate that FIG. 2 is an illustrative example of a distribution system in accordance with embodiments disclosed herein, and that components shown may be omitted, duplicated, or combined without departing from the scope herein. For example, while two substations are shown in FIG. 2, there may be any number of substations with any number of suitable reactors and converters associated with each power substation in the power distribution system (20).

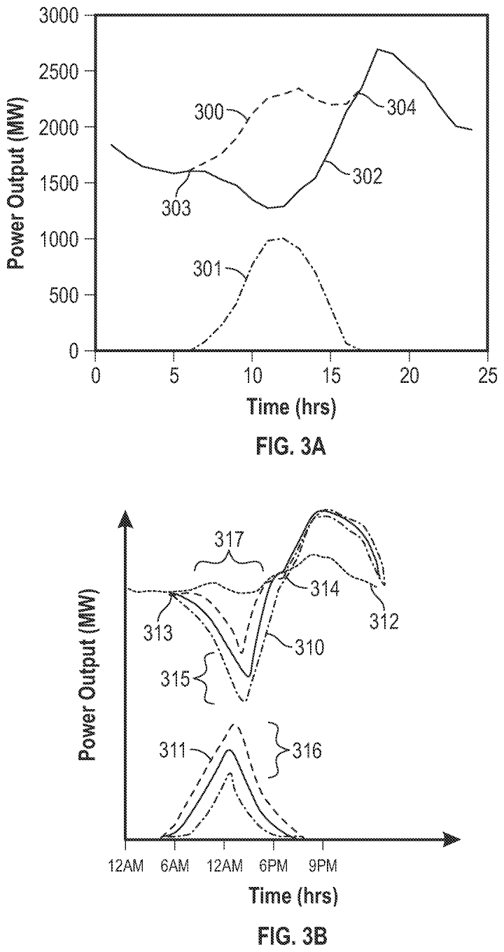

FIG. 3A are examples of one or more power curves depicting the power curve data (142) in accordance with one or more embodiments. The vertical axis represents the power output (118) in MW and the horizontal axis represents the time in hours (“hrs”). In some embodiments, the time zero on the horizontal axis may represent midnight. The system display (132) may be utilized to display the power curve depicting the power curve data (142). Power curve (300) shows load demand versus time of a conventional power plant. Power curve (301) shows the power output of an unconventional power plant configured to use solar energy for power generation. The unconventional power plant may include power sourced from one or more commercial-sized solar power systems and/or one or more residential-sized solar power systems. As the solar power system ramps up during the daylight hours, the conventional power plant may reduce power output (118) to prevent over frequency and to prevent failure of equipment within the power distribution system (20). The ramping down of the conventional power plant may begin at inflection point (303). The power generation system (100) is configured to vary the power output (118) of the various power plants so as to meet the load demand represented by the power curve (300). Curve (302) is the power output of the conventional power plant when potentially paired with another power plant such as the solar power system (116). The PMS (130) may be configured to control the power output (118) of the generation system based, at least in part, on the one or more power curves. Even though curve (300) is partially shown, it will be apparent to someone skilled in the art that curve (300) follows curve (302) before divergence at or near inflection point (303) and after convergence at or near inflection point (304).

In accordance with one or more embodiments, as the power generation of the solar power system ramps down, the conventional power plant ramps up to meet the load demand of the one or more subregional grids. The ramp up and/or down of the conventional power plant puts stress on the systems needed to generate power. At inflection point (304), the load demand begins to exceed the power output (118) and the power distribution system (20) may be at risk of overload and equipment failure.

FIG. 3B are examples of power curves depicting the power curve data (142) in accordance with one or more embodiments. Embodiments of the present invention direct power output (118) to two or more subregional grids using the flexibility of the back-to-back converter power transmission system (25) controlled by the PMS (130). Power curve (310) shows the net load demand versus time of an electrical system with minimum power transmission through the back-to-back transmission to other regions. Power curve (311) shows the minimum power transmitted through the back-to-back transmission system to other regions. Power curve (312) shows a targeted net load curve which can be achieved through one or more subregions power transmission. The ramping down of the conventional power plant may begin at inflection point (313). The low point in the power curve (310) represents a low demand from the conventional power plant as the power output (118) from the solar power system (e.g., power plants configured to use commercial and/or residential solar power systems) increases as depicted in the increase in magnitude (316) of the solar power output. As the PMS (130) selectively directs power output (118) to two or more subregional grids as the load demand of each subregional grid is monitored by the PMS (130), the magnitude (315) of the low point in the power curve (310) is reduced and the power curve (310) is flattened shown by the multiple decreases in the magnitude (315). As the power curve (310) is flattened, the distance (317) is reduced between inflection point (313) and inflection point (314).

In some embodiments, the PMS (130) may be used to direct part of the conventional generation to charge at least part of the storage system at daytime to use it during the load ramp up at night.

In accordance with one or more embodiments, as the power curve (310) continues to ramp up, the power output (118) begins to increase to meet ramp up of the load demand after inflection point (314). The PMS (130) may be configured to direct at least a portion of the power storage system (115) to handle the at least part of the load demand ramp up.

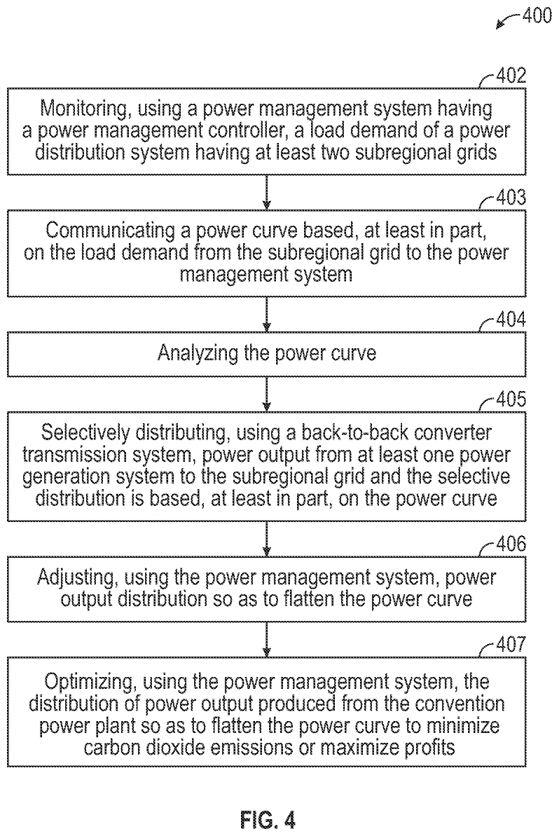

FIG. 4 depicts a flowchart in accordance with one or more embodiments describing a method for power transmission (hereafter “transmission method”) (400). In some embodiments, the transmission method (400) uses the power system (10) as described in relation to FIG. 1 to FIG. 3 and accompanying description. Although the steps in flowchart using the transmission method (400) are shown in sequential order, it will be apparent to one of ordinary skill in the art that some steps may be conducted in parallel, in a different order than shown, or may be omitted without departing form the scope of the invention.

In step (402), the transmission method (400) may include monitoring, using the PMS having the PMS controller (140), a load demand (e.g., the power curve (302)) of the power distribution system (20) in accordance with one or more embodiments. In some embodiments, the power distribution system (20) may include at least two subregional grids. The PMS controller (140) is configured to monitor the load demand of the power distribution system (20) having one or more subregional grids.

In step (403), the transmission method (400) may include communicating a power curve (e.g., power curve (310), and power curve (311)) based, at least in part, on the load demand (e.g., the power curve (302)) from the subregional grids to the PMS (130) in accordance with one or more embodiments. The PMS controller (140) may be configured to communicate the one or more power curves.

In step (404), the transmission method (400) may include analyzing the one or more power curves in accordance with one or more embodiments. The PMS controller (140) may be configured to analyze the one or more power curves. In some embodiments, analyzing the one or more power curves may include, but not limited to, comparing the load demand (e.g., the power curve (302)) and/or the power output (e.g., power curve (310) and/or power curve (311)) (118). The PMS controller (140) may be configured to compare various power curves. In some embodiments, analyzing the one or more power curves may include detecting one or more inflection points. At least one inflection point may be determined when the rate of change of the power curve is greatest (e.g., inflection point (314)). The PMS controller (140) may be configured to detect the one or more inflection points of each power curve.

In step (405), the transmission method (400) may include selectively distributing, using the back-to-back transmission system (25), power output (118) from at least one power generation system (100) to each subregional grid (210) in accordance with one or more embodiments. The power distribution system (20) may be configured to selectively distribute power from the one or more power generation systems (100) to the one or more subregional grids. In some embodiments, the selective distribution is based, at least in part, on the one or more power curves (e.g., the load demand, and/or power output). Selectively distributing power may include adjusting the direction and magnitude of power output (118) to the one or more subregional grids. The transmission method (400) may include using machine-learning methods, as described in reference to FIG. 1, to automate the adjustment of the direction and magnitude of power output (118) to various subregional grids.

In step (406), the transmission method (400) may include adjusting, using the PMS (130), power output distribution so as to flatten the power curve (e.g., the power curve (310)) in accordance with one or more embodiments. The power curve to flatten could be the load demand of one or more subregional grids from a conventional power plant.

In step (407), the transmission method (400) may include optimizing, using the power management system, the distribution of power output produced from a conventional power plant so as to flatten the power curve to minimize carbon dioxide (CO₂) emissions in accordance with one or more embodiments. The PMS (130) may be configured to optimize the distribution of power output produced from the convention power plant so as to flatten the power curve to minimize carbon dioxide emissions. In some embodiments, reducing CO₂ emissions may include optimizing power output distribution to the two or more subregional grids within the power distribution system (20). In some embodiments, machine-learning methods, as described in reference to FIG. 1, may be utilized to automate the optimization of the power distribution system (20).

In some embodiments, the transmission method (400) may include directing, using the PMS (130), at least a portion of power produced by the power generation system (100) to the power storage system (115). The power storage system (115) may include at least one battery. In some embodiments, at least a portion of the power produced from the power generation system (100) may be directed, using the PMS (130), to be stored by the power storage system (115) at one of the inflection points of the power curve. The PMS (130) may be configured to direct at least a portion of power produced from the power generation system (100) to be stored by the power storage system (115) at one of the inflection points of the power curve.

FIG. 5 further depicts a block diagram of a computer system (500) that includes one or more computers used to provide computational functionalities associated with described algorithms, methods, functions, processes, flows, and procedures as described in this disclosure, according to one or more embodiments. The illustrated computer system (500) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (502). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or another suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504) includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer processor (505). Although illustrated as a single computer processor (505) in FIG. 5, two or more processors may be used according to particular needs, desires, or particular implementations of the computer (502). Generally, the computer processor (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). The memory may be a non-transitory computer readable medium. For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), wherein each computer (502) communicates over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

Embodiments of the present disclosure may provide at least one of the following advantages. The present invention may allow for the optimization of the power grid including the subregional grids to flatten the power curve (e.g., the load demand). The optimization of the power grid may reduce CO₂ emissions as the efficient use of conventional power plants is improved by flattening the power curve. The consistent ramping up and ramping down of the conventional power plants is reduced and the efficient use of fossil fuels is improved.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for distribution of power, comprising:
using a power management system having a power management system controller:
monitoring a load demand of a power distribution system having at least two subregional grids;
communicating a power curve based, at least in part, on the load demand from each subregional grid to the power management system;
analyzing the power curve;
selectively distributing, using a back-to-back converter transmission system, power from at least one power generation system to each subregional grid, wherein the selective distribution is based, at least in part, on the power curve.

2. The method of claim 1, further comprising:
adjusting, using the power management system, power output distribution so as to flatten the power curve.

3. The method of claim 1, further comprising:
wherein the power distribution system comprises a power storage system having at least one battery,
directing, using the power management system, at least a portion of power produced by the at least one power generation system to the power storage system.

4. The method of claim 1, further comprising:
wherein the power generation system comprises a conventional power plant;
optimizing, using the power management system, the distribution of power produced from the convention power plant so as to flatten the power curve to minimize carbon dioxide emissions or maximize profits.

5. The method of claim 1,
wherein a mode of transmission, using the back-to-back converter transmission system, to each subregional grid is alternating current (“AC”) power transmission.

6. The method of claim 1, wherein analyzing the power curve comprises detecting at least one inflection point,
wherein the inflection point is determined when a rate of change of the power curve is greatest.

7. The method of claim 6, further comprising:
wherein the power distribution system comprises a power storage system having at least one battery,
directing, using the power management system, at least a portion of power produced from the power generation system, to be stored by the power storage system at the inflection point of the power curve.

8. A system for distribution of power, comprising:
a power management system comprising a power management system controller configured to:
monitor a load demand of a power distribution system having at least two subregional grids;
communicate a power curve based, at least in part, on the load demand from each subregional grid to the power management system;
analyze the power curve;
a back-to-back converter transmission system configured to selectively distribute power from at least one power generation system to each subregional grid, wherein the selective distribution is based, at least in part, on the power curve.

9. The system of claim 8, wherein the power management system is configured to:
adjust power output distribution to each subregional grid so as to flatten the power curve.

10. The system of claim 8,
wherein the power distribution system comprises a power storage system having at least one battery,
wherein the power management system is configured to direct at least a portion of power produced by the at least one power generation system to the power storage system.

11. The system of claim 8, further comprising:
wherein the power generation system comprises a conventional power plant;
wherein the power management system is configured to optimize the distribution of power produced from the convention power plant so as to flatten the power curve to minimize carbon dioxide emissions or maximize profits.

12. The system of claim 8,
wherein the back-to-back converter transmission system is configured to use alternating current (“AC”) power transmission as a mode of transmission of power to each subregional grid.

13. The system of claim 8,
wherein the power management system is configured to:
analyze the power curve and detect at least one inflection point,
determine the inflection point when a rate of change of the power curve is greatest.

14. The system of claim 13, further comprising:
wherein the power distribution system comprises a power storage system having at least one battery,
wherein the power management system is configured to direct at least a portion of power produced from the power generation system, to be stored by the power storage system at the inflection point of the power curve.
